(19) United States
(12) Patent Application Publication
(10) Pub. No.: US 2008/0060688 A1
(43) Pub. Date: Mar. 13, 2008

(54) DISHWASHING MACHINE

(75) Inventor: JOSEF ARNOLD BUSER, SCHOENENBERG-KUEBELBERG (DE)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 11/850,945

(22) Filed: Sep. 6, 2007

(30) Foreign Application Priority Data
Sep. 8, 2006 (EP) EP06120384.0

(51) Int. Cl. B08B 3/04

(52) U.S. Cl. 134/56 D

(57) ABSTRACT

A dishwashing machine is capable of carrying out a normal washing program with a powder detergent as well as programs using solid detergents with additives having rinse aid properties and/or water softening properties. The machine includes a detergent dispenser having three chambers. Each chamber is adapted for a specific kind of detergent. The chambers include a sensor for detecting the presence of loaded detergent and for adjusting the washing program accordingly.

### BACKGROUND OF THE INVENTION

1. Field of the Invention

The present invention relates to a dishwashing machine capable of carrying out a normal dishwashing program using a powder detergent as well as programs using solid detergents with additives having rinse aid properties and/or water softening properties.

2. Description of the Related Art

It is well known in the art of dishwashers the possibility of using, instead of powder detergent and liquid rinse aid, solid compositions called “2 in 1” compositions since they performs the function of the detergent and of the rinse aid which, in the traditional washing programs, has to be added in a specific “ad hoc” dispenser. There are also available on the market so called “3 in 1” solid compositions that, in addition to the above two functions (detergent+rinse aid), contain further additives having water softening purposes, therefore eliminating the need of using the water softening device and therefore the use of salt for ion exchange resins regeneration. Quite recently, the detergent producers have launched on the market “4 in 1” and “5 in 1” solid compositions or tablets, which have also other properties like a special care for stainless steel or silver and for glasses; for the purpose of the present invention “4 in 1” and “5 in 1” compositions are equivalent to “3 in 1” compositions.

The appliance producers had to adapt the range of dishwashers to the new family of detergents. Several approaches have been adopted, for instance by adding a “2 in 1” and “3 in 1” button to the user interface of the machine as disclosed by DE 10220839 A1 or by adding an “ad hoc” program to the machine, as disclosed by EP 1362547 A1, according to which the regeneration function of the water-softening device is switched off. These known solutions make the use of the dishwasher more cumbersome since the user does not usually like to have complex user interfaces with many buttons and/or a selection of too many washing programs. Moreover, there is always the possibility that the user load a “2 in 1” or “3 in 1” composition and then he/she forgets to adjust the button/program accordingly, therefore leading to a poor result of the washing program.

### SUMMARY OF THE INVENTION

An aspect of the present invention is to provide a dishwashing machine which does not present the above mentioned drawbacks and which is very easy to use. A dishwasher according to the invention presents the features listed in the appended claims.

### BRIEF DESCRIPTION OF THE DRAWINGS

Other advantages and features of the present invention will become clear from the following detailed description of one embodiment of the invention, with reference to the attached drawings in which:

FIG. 1 is a perspective view of a dishwashing machine according to the present invention;

FIG. 2 is a detail in enlarged scale of FIG. 1, particularly a detail of the detergent distributor in which the lid is not shown for sake of clarity; and

FIG. 3 is a cross section taken along line III-III of FIG. 2.

### DETAILED DESCRIPTION OF THE PREFERRED EMBODIMENTS

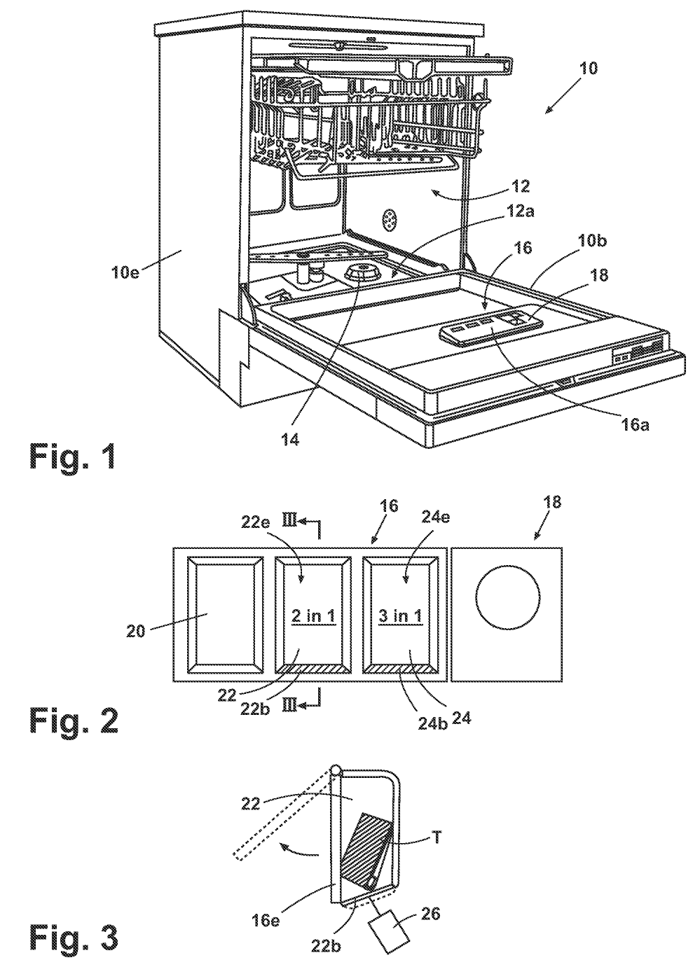

With reference to the drawings, a dishwasher 10 comprises a cabinet 10a and a front door 10b. The cabinet and the door define a washing chamber 12 having a bottom wall 12a where there is an opening for feeding salt used by the water-softening device for the regeneration of the ion exchange resins. In FIG. 1 only the lid 14 for closing the salt reservoir is shown.

On the door 10b a detergent distributor 16 is shown, near a distributor 18 for liquid rinse aid. The detergent distributor 16 is provided with an elongated rotating lid 16a covering three chambers 20, 22 and 24. The chamber 20 is intended for loading traditional powder detergent, and it may also be provided with a pre-wash basin. Chamber 22 is intended for loading tablets of solid detergent having also an additive performing a rinse aid function at the end of the washing program (the so called “2 in1” tablets). Chamber 24 is intended for loading tablets of solid detergent having additives performing a rinse aid function and a water softening function (the so called “3/4/5in1” tablets). For prompting the user to load the tablets in the correct chamber, chambers 22 and 24 present an indication 22a and 24a respectively (either on the bottom of the chamber, as shown in the drawings, or on the lid 16a) clarifying the purpose of each chamber. Therefore the user has no problem of loading the tablet in the correct chamber.

Each of chambers 22 and 24 presents a side wall 22b and 24b respectively made of flexible rubber like material so that, in the closed configuration of the door 10b, such side wall may be deformed by the weight of the solid detergent tablet if present in the chamber. This configuration is shown in FIG. 3 for the chamber 22, where it is shown a solid tablet T deforming by gravity the flexible wall 22b. Such wall, on the other side of the chamber 22, is in contact with a micro-switch 26 which sends a signal to the central process unit of the machine indicative of the presence of the “2in1” tablet. Due to this signal the machine automatically select or adjust a specific program sequence which is adapted for the “2in1” composition and which prevents the rinse aid distributor 18 from loading a rinse aid in the machine.

Similarly, when the micro-switch sensor indicates the presence of a “3in1” composition in the chamber 24, the machine automatically chooses a specific program sequence which prevents the activation of the rinse aid distributor 18 and prevents any regeneration of the resin of the water softening device, therefore bypassing such device.

Also the chamber 20 for powder detergent may be provided with a sensor as well; in order to reduce the cost of the machine such sensor is not strictly necessary since when sensors of chambers 22 and 24 indicate that no solid (tablet) detergent composition is present, the central process unit of the machine assumes that the user has loaded a powder detergent in chamber 20. A sensor in chamber 20 can guarantee that the machine does not start the washing program if no detergent is present, and an error message is set on the display accordingly.

Instead of using a micro-switch sensor, other sensors may be used as capacity sensors, foil switch sensors, reed sensors and the like.

As an alternative, each chamber 20, 22 and 24 may be provided with its own independent lid, and a micro-switch sensor can sense the closure of each lid. This system is very simple and such simplicity may counterbalance the disadvantage of a false signal when the chamber is closed but no detergent is placed in the chamber itself.

When a 3/4/5in1tablet is used, it is important to distinguish between a situation in which the water-softening device may be kept idle and a situation in which this could cause a not satisfactory washing performance. In other words, if the water hardness is higher than a predetermined value, for instance about 22° dH, the water softening properties of the 3/4/5in1composition is not enough for eliminating the water hardness and in this case the central process unit of the machine sets the regeneration/softening device accordingly and/or avoid a full by-passing of the water softener. When the machine has a switch for inputting the water hardness or it has a sensor for detecting automatically the hardness of water fed to the machine, the central process unit has stored therein a list of values corresponding to different rates of resin regeneration or water-softening by-passing. Such central process unit receives also signal from the sensors associated to the detergent distributor chamber 24. By combining the above information the central process unit can choose a specific rate of resin regeneration (and/or a specific degree of water softening device bypassing) in order to guarantee the proper water softening in the machine.

The processor or central process unit of the machine can have a sort of “head-up” table according to which, when a solid detergent composition having also water softening properties is used, deactivates any resin regeneration only if the hardness of water fed to the machine is lower than a predetermined value, for instance lower than about 21° dH. For higher value the central process unit chooses a predetermined degree of resin regeneration capable of supporting the insufficient water softening properties of additives in the detergent solid composition.

With a dishwasher as the one described above the user needs only to put the detergent composition in the right place (chamber); all the other selections or adjustments are carried out automatically by the machine.

We claim:

1. A dishwashing machine capable of carrying out a normal washing program with a powder detergent as well as programs using solid detergents with additives having rinse aid properties and/or water softening properties, comprising:
a detergent dispenser provided with chambers each for a specific kind of detergent, wherein,
each of the chambers being provided with a sensor for detecting the presence of loaded detergent and for adjusting the washing program accordingly.

2. The dishwashing machine according to claim 1, wherein the detergent dispenser has three chambers, one for powder detergent, the second one for a solid detergent composition having also rinse aid properties and the third one for a solid detergent composition having also rinse aid properties and water softening properties.

3. The dishwashing machine according to claim 2, wherein the three chambers have a single lid.

4. The dishwashing machine according to claim 2, wherein that each of the three chambers has its own lid.

5. The dishwashing machine according to claim 1, further comprising:
at least one wall of the chamber is made of flexible material; and
a sensor comprising a micro-switch, wherein:
the one wall can be deformed by the weight of the detergent, and
the sensor senses deformation of the wall and generates a signal indicative of the presence of the detergent in the chamber.

6. The dishwashing machine according to claim 1, wherein one of the sensors is a capacitive sensor capable of detecting the presence of detergent in the chamber.

7. The dishwashing machine according to claim 4, wherein the sensor comprises a position sensor capable of detecting whether the lid of each chamber is open or closed.

8. The dishwashing machine according to claim 1, further comprising:
a means for determining water hardness value; and
a processor which stores water hardness values corresponding to different rates of resin regeneration,
wherein the processor uses the water hardness value to determine a rate of resin regeneration required to guarantee the proper softening in the machine.

9. The dishwashing machine according to claim 8, wherein the processor has a head-up table which deactivates any resin regeneration when a solid detergent composition having water softening properties is detected by one of the sensors.
